(19) United States
(12) Patent Application Publication
(10) Pub. No.: US 2003/0034934 A1
(43) Pub. Date: Feb. 20, 2003

(54) Electronic vanity display device

(76) Inventor: Jacob Brewer, Knoxville, TN (US)

Correspondence Address: JACOB BREWER, 10042 DOUBLE TREE RD., KNOXVILLE, TN, 37932, US

(21) Appl. No.: 10/255,194

(22) Filed: Sep. 26, 2002

Related U.S. Application Data
(63) Continuation-in-part of application No. 10/039,421, filed on Jan. 2, 2002.
(60) Provisional application No. 60/259,580, filed on Jan. 2, 2001.

(51) Int. Cl. G09G 5/00

(52) U.S. Cl. 345/1.1

(57) ABSTRACT

A method and apparatus for an electronic vanity display device (10) comprising a vanity display screen (30) that is affixed to a commercially or privately owned method of ground transportation (50) for viewing text, graphics, and digital photographs. Also comprised of soft vanity display screens 240,260,270,290,300 and 310 which are affixed to an apparatus for transportation for viewing text graphics and digital photographs in the form of advertising and general use. The electronic vanity display device (10) further comprises a display composition computer (20) used to create a composition of text, graphics, and digital photographs that is displayed using the vanity display screen (30) and soft vanity display screens 240,260,270,290,300 and 310. The composed text and graphics can be edited and displayed at any time by the operator of the display composition computer (20). The vanity display device may display previously constructed compositions that are input from various electronic or optical storage media via the display composition computer (20). The vanity display device (10) may be connected to the Internet through the use of a wireless communications device (such as a cell phone) to download text, graphics, photographs, or previously constructed compositions and vanity displays.

### FIELD OF INVENTION

The present invention relates generally to vehicular display devices. In particularly, the present invention relates to an electronic vanity display device for mounting on an apparatus for transportation. In particular, the present invention relates to electronic, interactive, bumper stickers for private and commercial venues and for the content of advertising and general use.

### BACKGROUND OF THE INVENTION

There are many ways that private citizens express their thoughts and feelings by placing printed material onto methods of ground transportation. The expression of these thoughts and feelings have taken physical, three dimensional form as well, comprised of a composition of wood, metal, plastics, clay and other common construction materials in the shape of various objects that are displayed in or on a method of ground transportation.

A standard method for private citizens to express their thoughts and feelings is to construct or purchase a bumper sticker and place the bumper sticker onto the outside of a method of ground transportation, preferably towards the rear of the method of ground transportation and on the rear bumper or aperture of a method of ground transportation. Unfortunately, once the bumper sticker is placed onto the automobile, it may soon become outdated with respect to the ground transportation owner's present thoughts or feelings. The common ground transportation bumper sticker is constructed to remain on the bumper regardless of the types of weather that it experiences and is therefore not easily removed if so desired. Hence, this particular set of prior art methods and devices has been unable to adequately address the ability of a ground transportation owner to express different thoughts or feelings easily and in a timely manner. Attempts to use bumper stickers to reflect the present thoughts or feelings of any ground transportation owner have therefore met with limited success.

As further example, to address the bumper sticker problem, Courtney, U.S. Pat. No. 5,622,389, describes a bumper device and method to provide a hassle-free system for mounting and replacing bumper stickers. The bumper sticker device is attached to the bumper using Velcro strips to permit easy removal. However, the method and apparatus requires the reconstruction or repurchase of a second bumper sticker, with the additional step of preparing it with Velcro strips for use with the apparatus, to change the first bumper sticker to a second one. Therefore, the attempt to employ the Courtney bumper sticker apparatus to reflect the present, changing thoughts or feelings of a ground transportation owner meets with limited success.

Reas, U.S. Pat. No. 5,099,594, describes a ground transportation-mounted message display with suction cups and interposed hook and loop fasteners. The message display comprises a dry-erase message board that can be displayed on the interior surface of the ground transportation window. The message board can be temporarily detached from the affixing mechanism so that any desired message can be written, displayed, erased, or changed on the board. Once the desired changes are completed, it is reattached. The method and apparatus does not provide for the messaging and imaging possibilities that are presently available through the use of graphics software on standard laptop computers. The messaging process is slow and cumbersome. A further example of a limited display composition ability is illustrated by Kinloch, U.S. Pat. No. 4,470,214. Kinloch describes a display sign for the rear window area of a method of ground transportation, in which different posters are displayed. A poster placed in the display sign may be removed so as to place a second different poster. Again, the messaging process is slow and cumbersome. Therefore, attempts to employ the Reas message display apparatus or the Kinloch display sign apparatus to reflect the present, changing thoughts or feelings of a ground transportation owner meets with limited success.

The present invention represents an electronic vanity display device comprising a display screen that is affixed to a commercially or privately owned apparatus for transportation for viewing text, graphics, and digital photographs in the form of vanity displays and in the contexts of advertising and general use. The electronic vanity display device further comprises a display composition computer used to create a composition of text, graphics, and digital photographs that is displayed using the vanity display screen. The display composition computer is mounted or placed inside the apparatus for transportation to provide quick and easy access to the composition software operating on the display composition computer. The composed text and graphics can be edited and displayed at any time by the operator of the display composition computer.

The present invention also represents an electronic vanity display device comprising a vanity display screen for viewing text, graphics and digital photographs in the form of vanity displays and in the contexts of advertising and general use located inside an apparatus for transportation and a display composition computer attached directly to the vanity display screen used to create a composition of texts, graphics and digital photographs in the form of private or commercial vanity displays for viewing.

The preset invention further represents an electronic vanity display device comprising a soft vanity display screen for viewing hand written messages in the form of vanity displays and in the contexts of advertising and general use and a on/off panel in which to turn the electronic vanity display device on and off.

The present invention further represents an electronic vanity display device comprising multiple vanity display screens, multiple soft vanity display screens and multiple display composition computers being used at the same time by multiple operators to create an accumulative vanity display or separate vanity displays simultaneously in the same apparatus for transportation. Said composition computers create a composition of texts, graphics and digital photographs in the form of private and commercial vanity displays for viewing.

The present invention also represents an electronic vanity display device comprising a vanity display screen for viewing text, graphics and digital photographs in the form of vanity displays and in the contexts of advertising and general use and a soft vanity display screen that is constructed into the shape and to the specifications thereof of body parts of an apparatus for transportation with a display composition computer attached directly to it to create, combine and compose private and commercial vanity displays for viewing.

The present invention also represents a display screen and a soft vanity display screen for viewing text, graphics and digital photographs in the form of vanity displays and in the contexts of advertising and general use constructed to the shape and specifications thereof of the entire inside and outside frame and framework of an apparatus for transportation, and further comprising a display composition computer used to create compositions of texts, graphics and digital photographs in the form of private and commercial vanity displays for viewing. Implementing the latter representation of this invention onto apparatus' of transportation such as a trolley, bus, subway and big rig semi-trailer will create a new and vital advertising sub-culture and allow this advertising sub-culture to flourish. We have applied the electronic vanity display device to overcome these limitations. There are no such teachings in the prior art. Therefor we must conclude that all prior art meets with limited success.

Smith, U.S. Pat. No. 5,105,179, describes a method and apparatus for an electronic display license plate and message center for use on any method of ground transportation. The electronic display license plate is a replacement for the standard metal license plate. Further, the configuration cartridge, such as a read only memory, contains such information as license plate data. However, this invention does not permit any ability to use this information, or any other electronically stored information, to express a ground transportation owner's present thoughts or feelings. Further, in the background for Smith, a good review of the existing prior art regarding a license plate and message center apparatus clearly demonstrates that no prior art apparatus provides an electronic bumper sticker that may be reconfigured with general, electronically stored data that may be composed to express a ground transportation owner's present thoughts or feelings. The U.S. Pat. No. 5,105,179 is thereby incorporated herein by reference in its entirety.

### SUMMARY OF THE INVENTION

The present invention is an apparatus to provide interactive, electronic, real-time adaptable, vanity displays to a display screen that is attached to an apparatus for transportation. An operator or passenger of an apparatus for transportation uses the electronic vanity display device to construct, compose, or combine vanity displays that are electronically posted real-time to the vanity display screen. The electronic vanity display device comprises a display composition computer located within an operator or passenger seating area of said method of transportation, a vanity display screen attached to said method of transportation, and a wiring harness connected to said display composition computer and connected to said vanity display screen. The display composition computer is used by the apparatus for transportation's operator or passenger to interactively communicate one or more electronic displays to the display screen.

Further the apparatus of the present invention is an electronic vanity display device that comprises a vanity display screen and a soft vanity display screen for viewing text, graphics and digital photographs in the form of private and commercial vanity displays and in the contexts of advertising and general use situated on an apparatus for transportation and a display composition computer attached directly to it to create, combine and compose vanity displays for viewing.

Further the apparatus of the present invention is an electronic vanity display device comprising a soft vanity display screen in which to view hand written messages in the form of vanity displays and in the contexts of advertising and general use and an on/off panel in which to turn the electronic vanity display device on and off. The apparatus of this representation of the present invention is a giant soft screen and reacts to the operators touch much in the same way as a body part of an apparatus for transportation that has a lot of dirt and silt spread upon it does. The most common signage for the illustration mentioned is ‘clean me please’.

Further the apparatus of the present invention is an electronic vanity display device comprising multiple vanity display screens and multiple soft vanity display screens for viewing text, graphics and digital photographs in the form of private and commercial vanity displays and in the contexts of advertising and general use and multiple display composition computers to create, combine and compose vanity displays being used by multiple operators to create an accumulative vanity display or separate vanity displays simultaneously in the same apparatus for transportation.

The present invention is an apparatus to create an entire new and flourishing sub-culture for advertising by an electronic vanity display device comprising a vanity display screen and a soft vanity display screen for viewing text, graphics and digital photographs in the form of private and commercial vanity displays and in the contexts of advertising and general use with display composition computer capabilities that is formed and constructed in the shape and to the specifications thereof of body parts of an apparatus for transportation.

Also an electronic vanity display device comprising a vanity display screen and a soft vanity display screen for viewing text, graphics and digital photographs in the form of private and commercial vanity display and in the contexts of advertising and general use that is constructed in and over the entire inside and outside frame and framework and to the specifications thereof of an apparatus for transportation. Thus the vanity display screen and soft vanity screen of the present invention covers some and most and all of the body of an apparatus for transportation. The apparatus of the present invention is constructed upon apparatus' of transportation such as big rig semi-trailers and buses and trolleys and trains and subways whereby an entire new and vital sub-culture for advertising will be created and flourish.

The benefits of this invention will become clear and will be best appreciated with reference to the detailed description of the preferred embodiments. Other objects, advantages and novel features will be apparent from the description when read in conjunction with the appended claims and attached drawings.

### OBJECTS AND ADVANTAGES

Furthermore, the Electronic Vanity Display Device has the additional advantages in that it permits the user to change the displayed composition at anytime they feel that they've grown out of the old one without the reapplication of physical material displays; it permits the user to create new display compositions without further cost of physical material; it allows the user to create display compositions in conjuncture with new technology and application methods such as electronically stored media and electronically updated media via the Internet; and it provides a way a person can actively exhibit there current changing thoughts and feelings via real-time adaptability.

Further still the electronic vanity display device creates an important new part to the economy by creating a new and vibrant advertising sub-culture and helping it to flourish. It creates new themes for rental and business transportation vendors and it creates and entire new venue for transportation advertising and as it creates new themes it will inevitably create more jobs. These jobs will be filled by people needing employment and those people will feel more inclined to take up space in the consumer properties sector of our economy thus creating a stronger and healthier one.

### DRAWING FIGURES

FIG. 1 illustrates the electronic vanity display device attached to a method of ground transportation, comprising the display composition computer, the vanity display screen, and the connecting power and communication harness.

FIG. 2 illustrates a frontal view of the display composition computer with buttons for operation and interaction.

FIG. 3 illustrates a frontal view of the electronic vanity display screen.

FIG. 4 illustrates the electronic vanity display device attached to a method of ground transportation, comprising the soft vanity display screen and a display composition computer attached to the back and further comprised of a media sharing apparatus.

FIG. 5 illustrates the electronic vanity display device attached to a method of ground transportation, comprising a soft vanity display screen with a display composition computer attached to the front.

FIG. 6 illustrates the electronic vanity display device attached to an apparatus for transportation, comprising a soft vanity display screen and an on and off panel.

FIG. 7 illustrates the electronic vanity display device attached to a method of ground transportation, comprising a soft vanity display screen with multiple display composition computers.

FIG. 8 illustrate the electronic vanity display device attached to a method of ground transportation, comprising a soft vanity display screen and a display composition computer constructed in the shape and to the specifications thereof of a piece and a body part of an apparatus for transportation.

FIG. 9 illustrates the electronic vanity display device constructed to a method of ground transportation, comprising a soft vanity display screen and a display composition computer constructed in the shape and to the specifications thereof and over the body and the entire inside and outside frame and frame work of an apparatus for transportation

FIG. 10 illustrates the electronic vanity display device , comprising multiple vanity display screens constructed to the shape and specifications of a logo and form and shapes and a wiring harness and a display composition computer.

FIG. 11 illustrates the electronic vanity display device attached to an apparatus for transportation, comprising a soft vanity display screen with an audio speaker and a display composition computer and wiring harness.

FIG. 12 illustrates the media sharing apparatus, comprising a sensor eye, video camera and storage facilities.

REFERENCE NUMERALS IN DRAWINGS

| | | | |
|---|---|---|---|
| 10 | electronic vanity display | 20 | display composition computer |
| | device | | |
| 30 | vanity display screen | 40 | wiring harness |
| 50 | ground transportation | 60 | display composition computer |
| | | | screen |
| 70 | digital pen | 80 | memory card drive |
| 90 | compact disk drive | 100 | cell phone data transfer port |
| 110 | battery recharging port | 120 | microphone |
| 130 | on and off switch | 140 | clip art graphics |
| 150 | foreground | 160 | background |
| 170 | folder | 180 | Internet connection |
| 190 | voice operation | 200 | affixing mechanism |
| 210 | background display lighting | 220 | foreground display |
| 230 | displayed foreground com- | 240 | soft vanity display screen |
| | position | | |
| 250 | audio speaker | 260 | soft vanity display screen |
| 270 | soft vanity display screen | 280 | on and off panel |
| 290 | soft vanity display screen | 300 | soft vanity display screen |
| 310 | logo vanity screen | 320 | media sharing apparatus |
| 330 | sensor eye | 340 | video camera |
| 350 | storage facilities | | |

### DESCRIPTION—PREFERRED EMBODIMENT

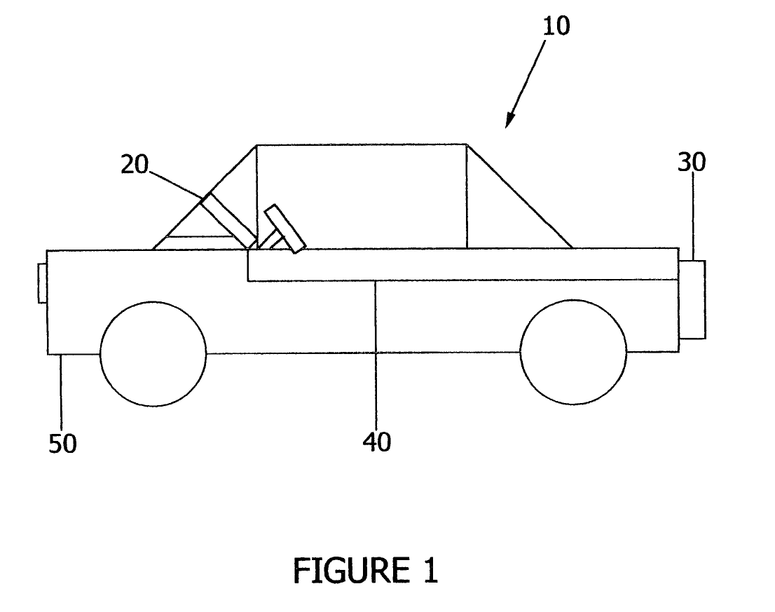

FIG. 1 illustrates the present invention in its preferred embodiment. The electronic vanity display device 10 comprises a vanity display screen 30 that is affixed to the exterior of commercially or privately owned ground, water, or air transportation 50 for viewing text, graphics, and digital photographs. The present invention is attached to an exterior part of any method of ground transportation 50, such as commercial or privately owned motor vehicles, automobiles, buses, trains, and subways and boats and ships and airplanes.

The vanity display device 10 further comprises a display composition computer 20 used to create a composition of text, graphics, and digital photographs that is displayed using the exterior vanity display screen 30. The display composition computer 20 is connected to the vanity display screen 30 by a wiring harness 40. The wiring harness 40 comprises at least one power wire and at least one communication wire from the display composition computer 20 to the vanity display screen 30.

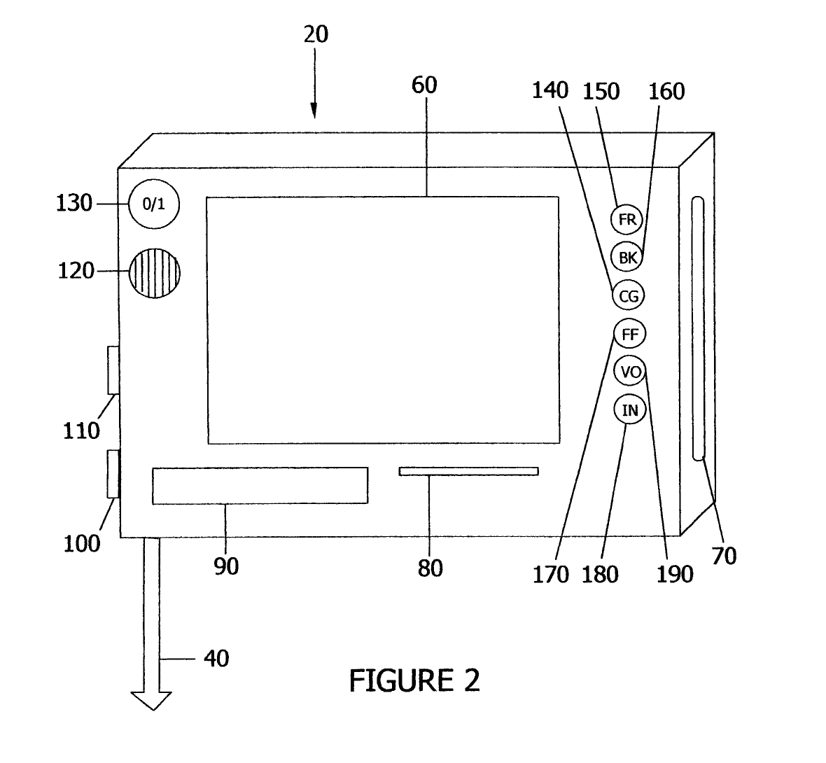

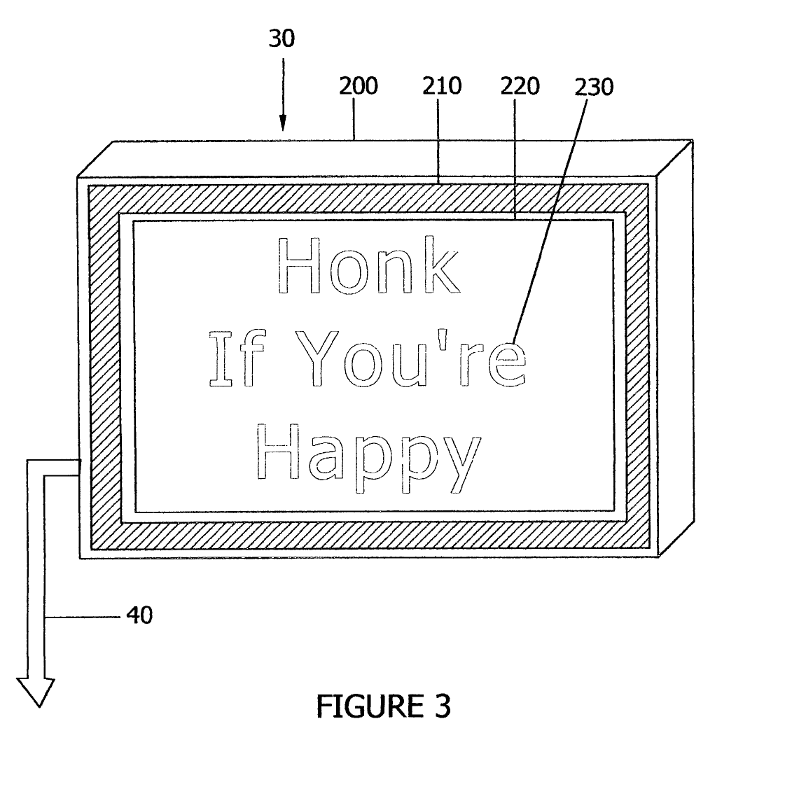

FIGS. 2 and 3 illustrate the display composition computer 20 of the present invention. The display composition computer 20 may take the form of a standard computer, such as a Macintosh or PC laptop. The display composition computer 20 may also be a portable workstation laptop. The display composition computer 20 may also take the form of a personal digital assistant device, such as a commercially available Palm Pilot or Handspring digital data display device.

The display composition computer 20 is turned on or turned off by using an on/off button 130. The display composition computer 20 is operated by pressing appropriate buttons 140, 150, 160, 170, 180, or 190 by touching the display composition computer screen 60 with a finger or a digital pen 70. A digital pen 70 and its holder slot 70 is located on a side of the display composition computer 20.

The display composition computer 20 has buttons to operate digital data to construct or compose vanity displays. The display composition computer buttons may be physically located on the display composition computer or may be virtually implemented as software buttons in the form of a touch screen and soft keys.

The foreground button 150 permits the user to compose the foreground of the vanity display. The vanity display foreground 230 comprises a combination of text, graphics, or photographs. The background button 160 permits the user to compose the background 210 of the vanity display.

The clip art graphics button 140 permits the user to draw from a large library or database of clip art graphics and photographs to be placed into the foreground 230 of the vanity display 220. The library or database of clip art graphics and photographs are stored on a hard disk drive within the display composition computer 20. The file and folder button 170 permits the user to save, delete, open, or close composed vanity displays as files within folders in a like manner as methods available through a Macintosh or PC operating system. The owner or user of the vanity display device places a selected vanity display onto the vanity display screen using the files and folder menu options.

The voice operation button 190 permits the user to operate the vanity display device by voice actuation. By pressing the voice operation button and by verbally stating simple commands, the display composition computer 20 uses a microphone 120 to intercept, interpret, and perform simple functions related to the commands. As an illustration, a first simple set of verbal commands opens a preexisting, predetermined vanity display and places the display onto the vanity display screen 30. As a further illustration, a second simple set of verbal commands opens a second, preexisting, predetermined vanity display and replaces the first display with the second display onto the vanity display screen 30.

The vanity display device 10 may be connected to the Internet through the use of a wireless communications device, such as a cell phone, to download text, graphics, and photographs. The vanity display device 10 may also download or upload fully constructed vanity display compositions. The Internet connection button 180 permits the user to connect to the Internet via the display composition computer 20 and a cell phone attached to a cell phone data transfer port 100. The display composition computer 20 uses the cell phone and cell phone data transfer port 100 to interactively communicate to the Internet.

The display composition computer 20 has several standard, commercially available subsystems that permit the transfer of data in the form of text, graphics, photographs, or composed vanity displays. The display composition computer 20 uses its memory card drive 80, compact disk (CD) drive 90, or cell phone data transfer port 100 to download or upload digital data and composed vanity displays to construct vanity displays interactively and in real-time.

The display composition computer 20 is powered by rechargeable batteries in a manner similar to present day cell phones. The display composition computer 20 supplies power to the vanity display screen 30 via the wiring harness 40. The owner of the vanity display device 10 and its display composition computer 20 may recharge the batteries using an adapter to access a home's or business' electricity supply to recharge the batteries. The owner may also recharge the batteries using an adapter to access a ground transportation apparatus' 50 electricity supply through its cigarette lighter or power outlet.

The display composition computer 20 is preferably mounted on the dashboard of the method of ground transportation 50. The mounting is a clip-on, such as is presently used for clipping cell phones to the dashboard of ground transportation 50. The display composition computer 20 may be lifted from the mounting and held by hand for operation. The text, graphics, and photograph pieces that comprise a vanity display composition can be edited and displayed at any time during the operation of the display composition computer 20. The vanity display screen 30 may display previously constructed compositions that are input from various electronic or optical storage media via the display composition computer 20.

The vanity display screen 30 is preferably attached to the exterior and rear of a method of ground transportation 50. The vanity display screen 30 allows a vanity display to be readily broadcast. The electronic vanity display screen 30 ranges from the size of an ordinary bumper sticker (approximately 12 inches long and 4 inches wide) to the size of a large television flat screen (approximately 48 inches long and 24 inches wide). Using a larger electronic vanity display screen 30 is beneficial for commercial transportation such as taxi cabs and buses and subways.

The vanity display screen 30 comprises an active liquid crystal display 220 such as a screen used for standard computer laptops. The vanity display screen 30 displays a vanity display communicated by the display composition computer 20, serving a display function comparable to a laptop computer screen. The vanity display device 10 is therefore able to create and display any display composition that is possible using standard computer software developed to combine text, graphics, or photographs. Examples of such computer software are Corel Draw and Adobe Illustrator. Also, the display composition computer 20 employs HTML and dynamic HTML capabilities to construct web page like displays to emulate Internet web page constructions. The web page constructions are an example of the vanity displays that can be composed. The web page constructions, as display compositions, are communicated to the vanity display screen 30 for display.

The vanity display screen 30 further comprises a background 210. The background 210 comprises a border surrounds the vanity display screen foreground 220 and that incorporates lights that are programmable via the background button 160 on the display composition computer 20. The background lighting 210 is programmable to operate display lights that illuminate the foreground 220 of the vanity display screen 30 for better viewing. The background lighting 210 is also programmable to activate its lights in a flashing manner and with an active and changing lighting pattern. The outer cover for the background lighting 210 is a plastic cover that is interchangeable. The plastic cover is colored clear or with colors that enhance the lighting of the foreground 220 or the lighting pattern displays.

The vanity display screen 30 may be attached in many different manners to the method of ground transportation 50 with an affixing mechanism 200. The vanity display screen 30 may be attached using bumper sticker glue, Velcro, or a metal back plate. The vanity display screen 30 is covered with a clear plastic material to protect the electronics from the weather and outside environment. Further, the plastic material further enhances the viewing of the vanity display screen 30. For example, the vanity display screen 30 may be mounted using the bumper device and method described in U.S. Pat. No. 5,622,389, incorporated herein by reference in its entirety. As a second example, the vanity display screen 30 may be mounted using the interchangeable display system for indicia described in U.S. Pat. No. 5,266,144, incorporated herein by reference in its entirety.

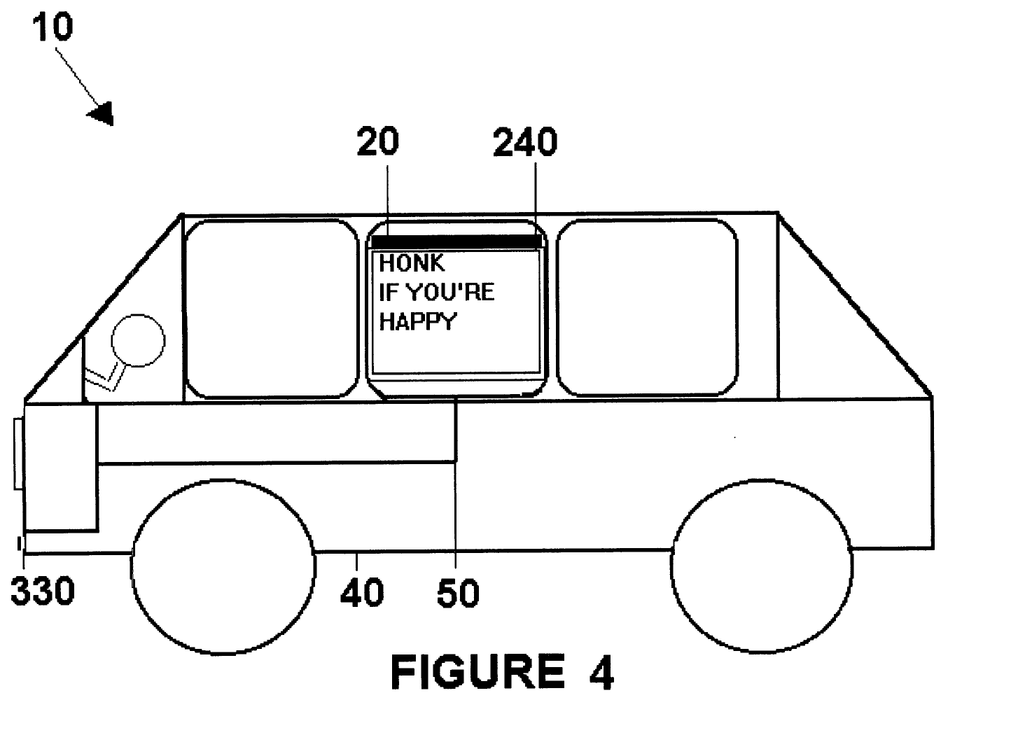

FIG. 4 illustrates the present invention in its preferred embodiment. The electronic vanity display device 10 is affixed to an apparatus for transportation 50 for viewing text, graphics and digital photographs in the form of private and commercial vanity displays and in the contexts of advertising and general use. The electronic vanity display device 10 comprises a soft vanity display screen 240 in which to view text, graphics and digital photographs in the form of private and commercial vanity displays and in the contexts of advertising and general use. A display composition computer 20 attached to the back of the soft vanity display screen in which to create vanity displays out of text, graphics and digital photographs and in the contexts of advertising and general use. The electronic vanity display device is powered by a wiring harness 40. The soft vanity display screen 240 for viewing text, graphics and digital photographs in the form of private and commercial vanity displays further comprises a media sharing apparatus 320. The media sharing apparatus is comprised of a sensor eye 330 and video camera 340 and storage facilities 350. They provide ways in which operators of such an apparatus when mobile or immobile can share media with each other. As an illustration, an operator of the electronic vanity display device 10 sends out preexisting and predetermined media with the sensor eye 330 of the media sharing apparatus 320 and an apparatus for transportation 50 that is in the line of sight of the sensor eye 330 that also has the electronic vanity display device 10 with a media sharing apparatus 320 can then choose to pick up that sent media and share media of its own in the same fashion. The video camera 340 of the present invention acts as a standard video recording unit. It is utilized to tape, play and record video footage. It can send footage to the vanity display screen 30 and soft vanity display screens 240, 260, 270, 290, 300, and 310. This footage can be combined with other media to create vanity displays and can be used alone as vanity displays and viewed on the vanity display screen 30 and soft vanity display screens 240, 260, 270, 290, 300 and 310.

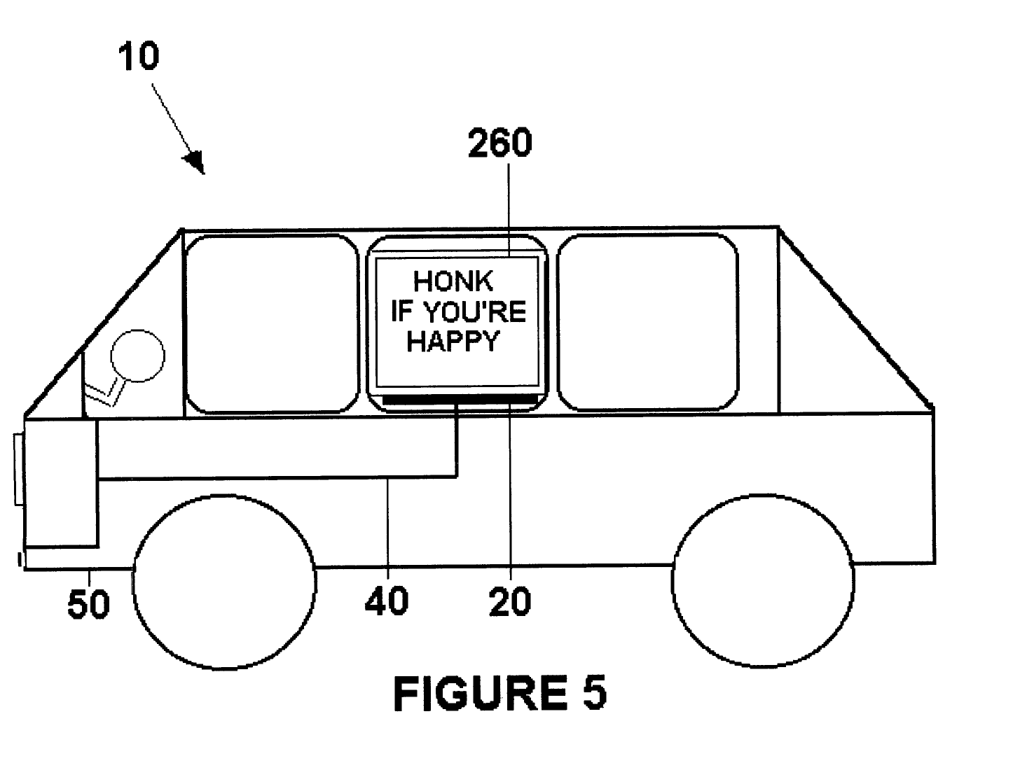

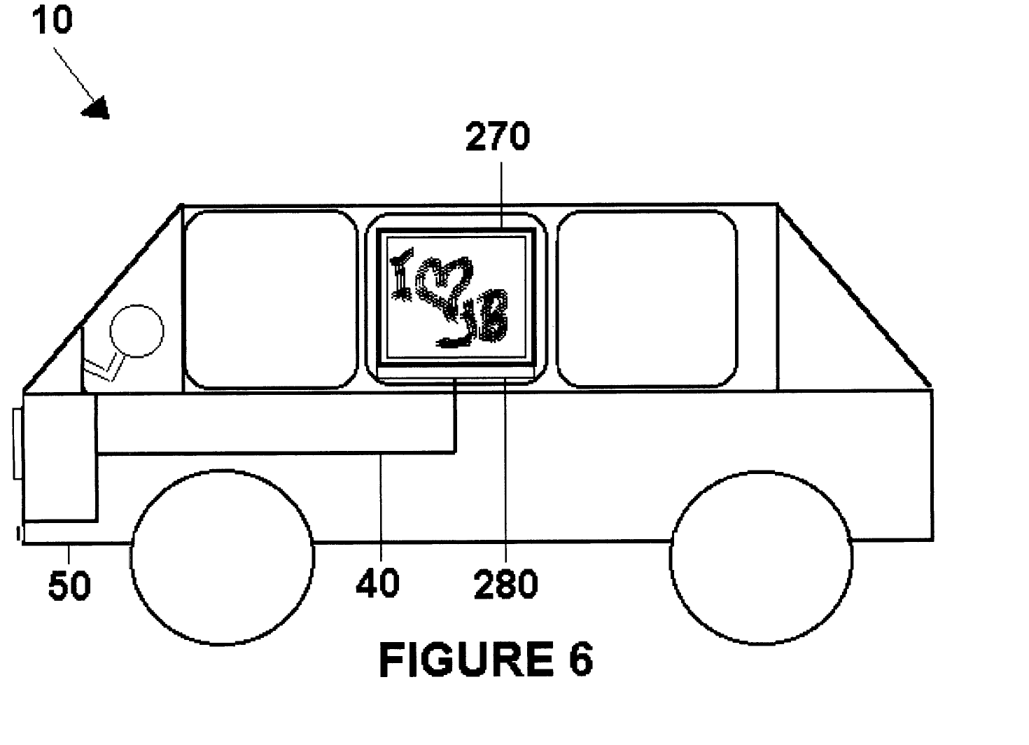

FIG. 5 illustrates the present invention in its preferred embodiment. The electronic vanity display device 10 is affixed to an apparatus for transportation 50 for viewing text, graphics and digital photographs in the form of private and commercial vanity displays and in the contexts of advertising and general use. The electronic vanity display device 10 comprises a soft vanity display screen 260 in which to view text, graphics and digital photographs in the form of private and commercial vanity displays and in the contexts of advertising and general use. A display composition computer 20 attached to the front of the soft vanity display screen in which to create vanity displays out of text, graphics and digital photographs and in the contexts of advertising and general use. The electronic vanity display device is powered by a wiring harness 40. FIG. 6 illustrates the present invention in its preferred embodiment. The electronic vanity display device 10 affixed to an apparatus for transportation 50 for viewing text, graphics and digital photographs in the form of private and commercial vanity displays and in the contexts of advertising and general use. The electronic vanity display device 10 comprises a soft vanity display screen 270 for viewing text, graphics and digital photographs in the form of private and commercial vanity displays and in the contexts of advertising and general use, with an on/off panel 280 in which to turn the electronic vanity display device on and off. This illustration of the preferred embodiment of the present invention is used by acting as a giant soft key and reacting to the operators touch. A further illustration for this invention can best be described with the general sayings of owners of apparatus' for transportation that have become filthy with mud and silt. The most common signage for this technique is “clean me please”.

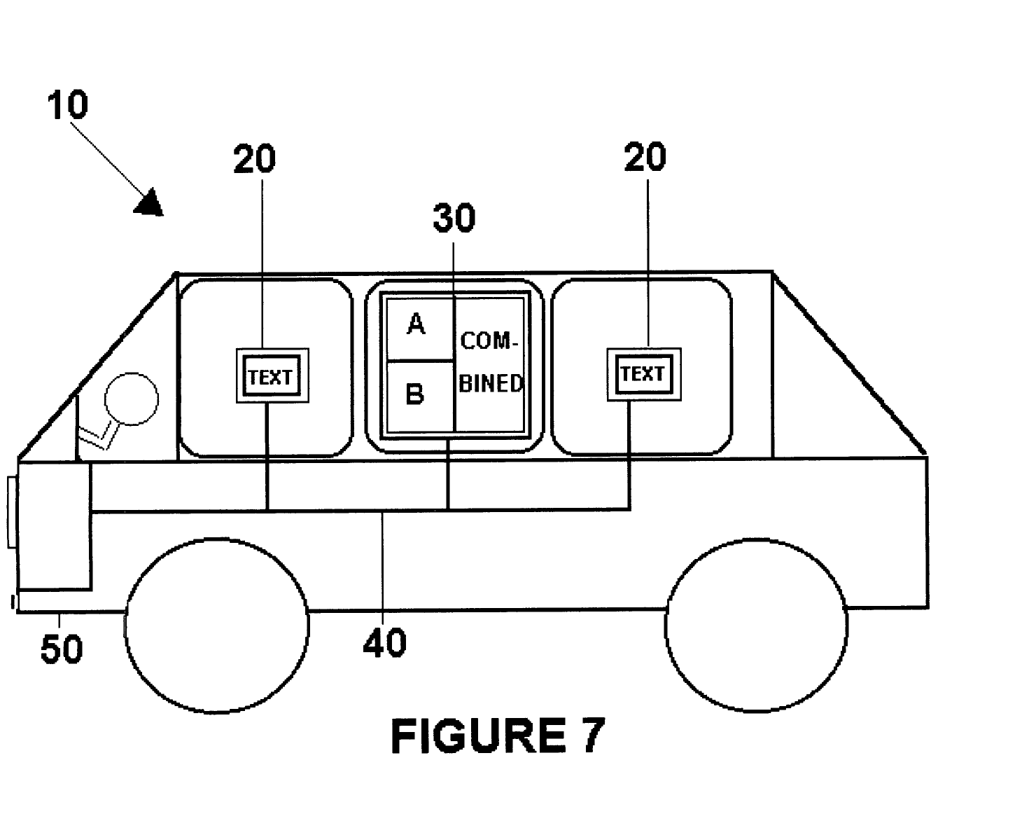

FIG. 7 illustrates the present invention in its preferred embodiment. The electronic vanity display device 10 is affixed to an apparatus for transportation 50 for viewing text, graphics and digital photographs in the form of private and commercial vanity displays and in the contexts of advertising and general use. The electronic vanity display device 10 comprises a vanity display screen 30 in which to view text, graphics and digital photographs in the form of private and commercial vanity displays and multiple display composition computers 20 to create, combine and compose vanity displays and to allow for the use of multiple operators creating one accumulative display or separate ones simultaneously in the same apparatus for transportation 50. As an illustration an operator is creating a vanity display on side A and another operator is creating a vanity display on side B. As further illustration, multiple operators work together to create a combined vanity display that will be mutually beneficial for them all.

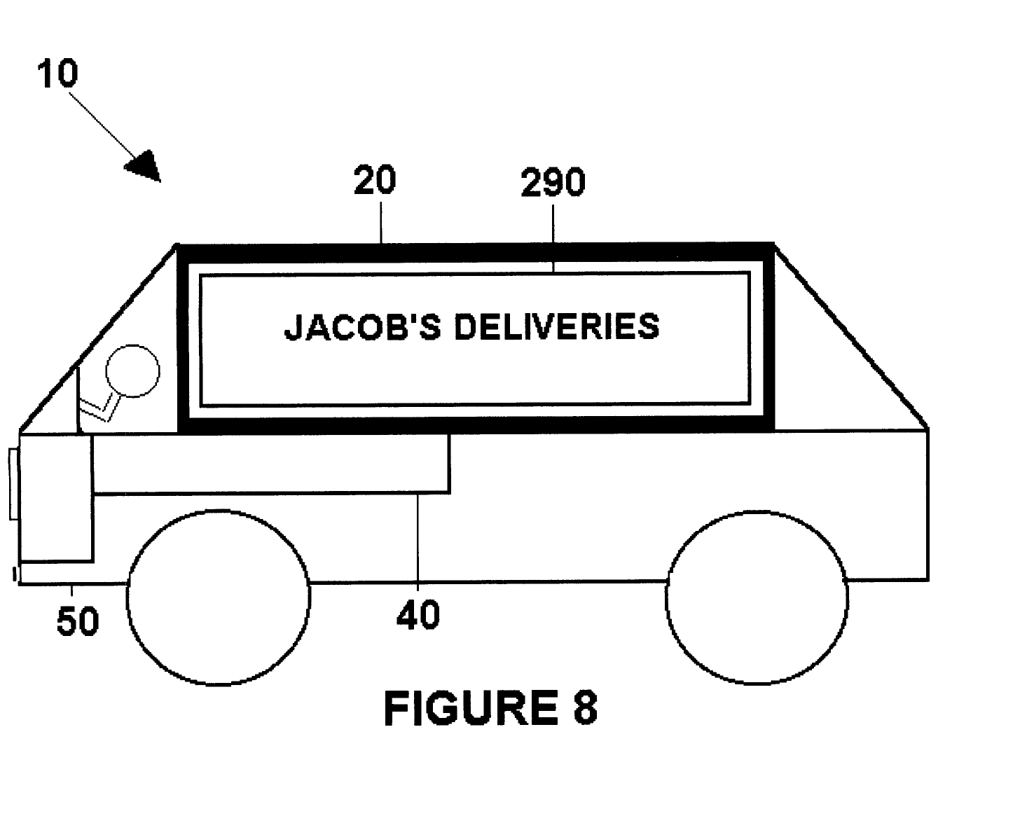

FIG. 8 illustrates the present invention in its preferred embodiment. The electronic vanity display device 10 is affixed to an apparatus for transportation 50 for viewing text, graphics and digital photographs in the form of private and commercial vanity displays and in the contexts of advertising and general use. The electronic vanity display device 10 comprises a soft vanity display screen 290 for viewing text, graphics and digital photographs in the form of private and commercial vanity display that is constructed in the shape and to the specifications thereof of body parts of an apparatus for transportation and fitted to the specifications of that shape. The soft vanity display device 290 further comprises a display composition computer 20 used to create, combine and compose vanity displays in the form of advertising and general.

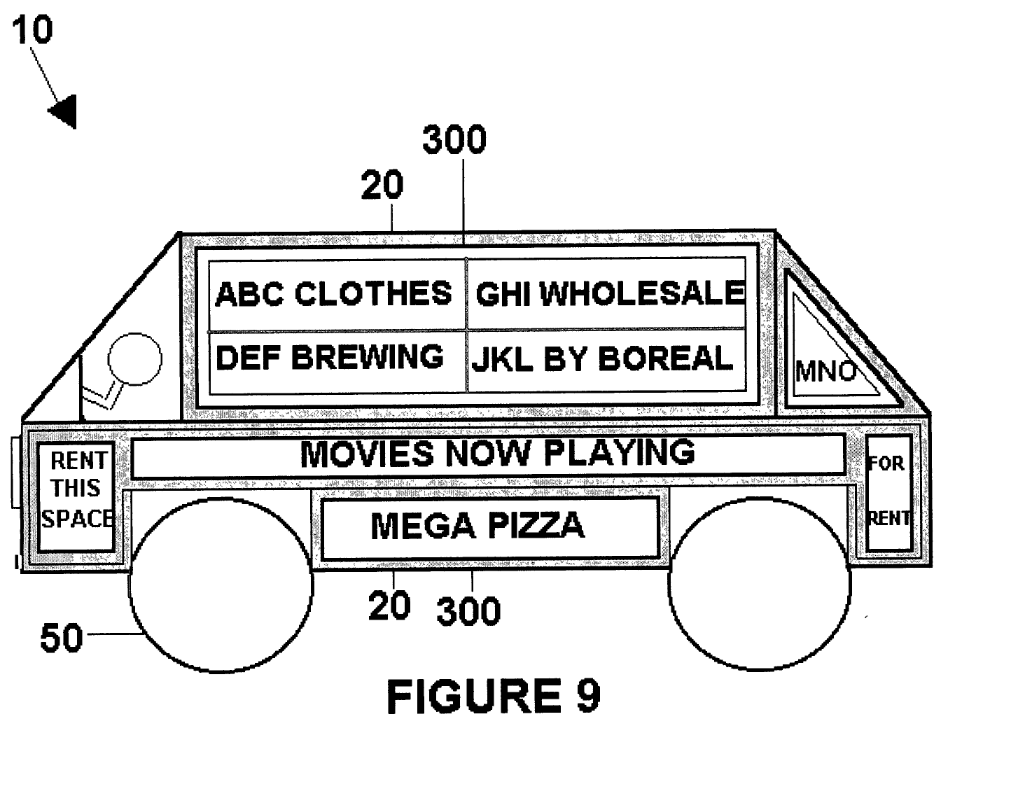

FIG. 9 illustrates the present invention in its preferred embodiment. The electronic vanity display device 10 is affixed to and built upon and around and fitted to the specifications of the shape of an apparatus for transportation 50 to create combine and compose text, graphics and photographs in the form of private and commercial vanity displays for advertising and for general use. The electronic vanity display device 10 comprises a soft vanity display screen 300 and hard vanity display screen 30 that is constructed upon and around the entire inside and outside frame and framework and is constructed to the specifications thereof of an apparatus for transportation for viewing private and commercial vanity displays in the contexts of advertising and general use. The electronic vanity display device 10 further comprises display composition computer 20 capabilities to create, combine and compose vanity displays utilized from the front.

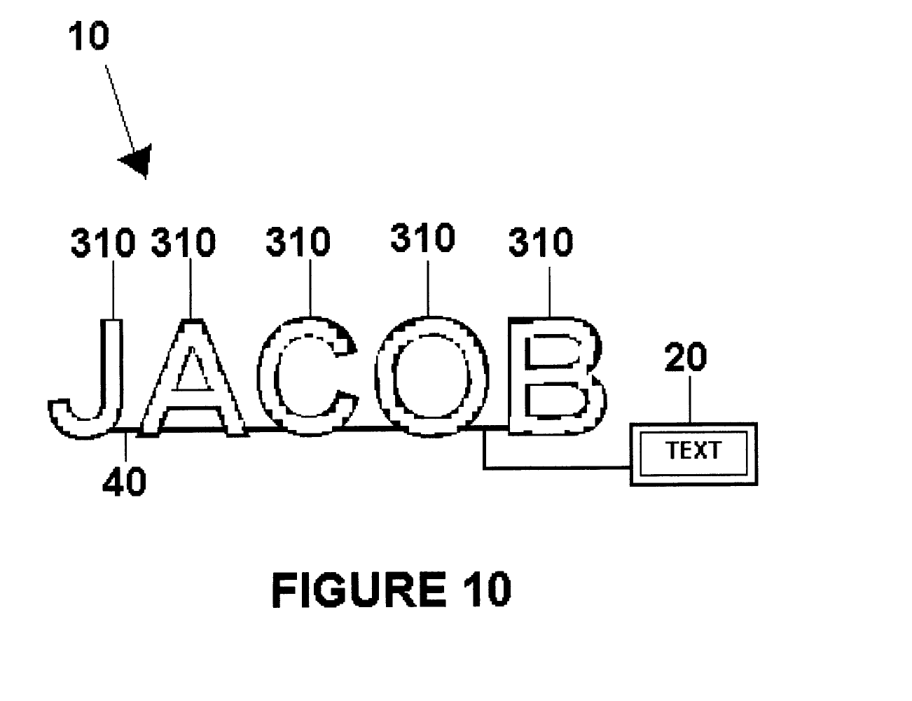

FIG. 10 illustrates the present invention in its preferred embodiment. The electronic vanity display device 10 is affixed to an apparatus for transportation 50 for viewing text, graphics and digital photographs in the form of private or commercial vanity displays and in the contexts of advertising and general use . The electronic vanity display device 10 further comprising a logo vanity screen 310 for viewing vanity displays which is constructed as a shape and logo of private and commercial designations such as signage specifications for a specific operator or vendor. A display composition computer 20 is attached to create, combine and compose vanity displays located within reach of the user. As an illustration a citizen of the private or commercial sector creates a logo for their business and constructs a vanity display screen 30 and soft vanity display screen 240, 260, 270, 290, 300, and 310 to the specifications of that logo

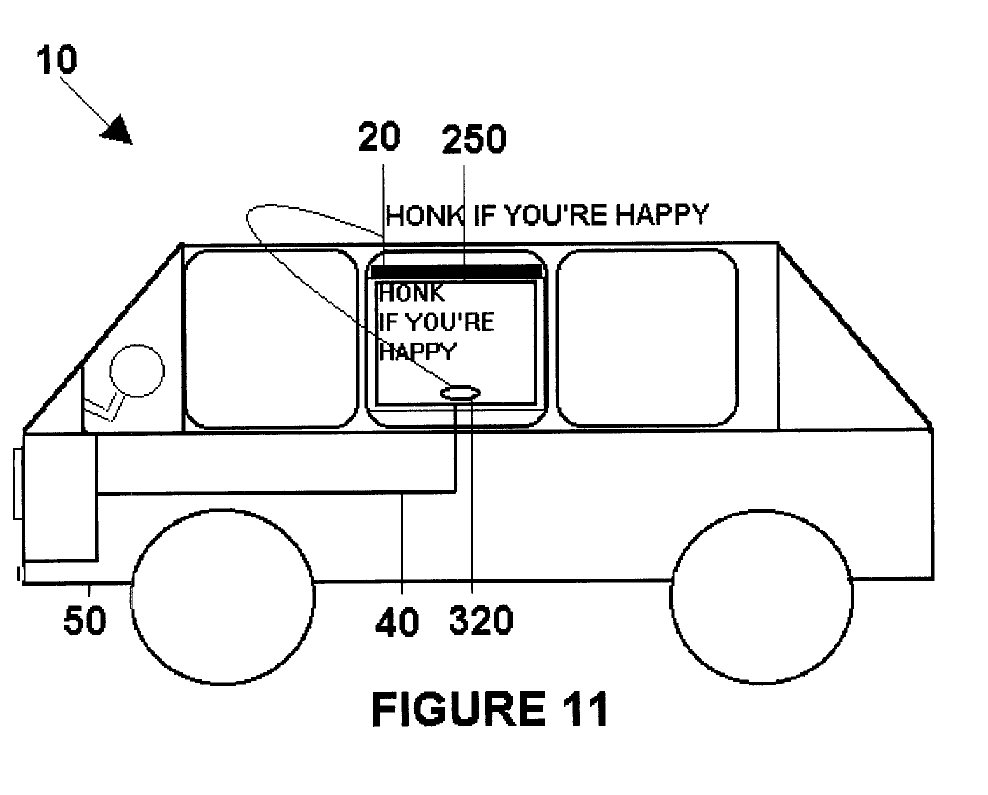

FIG. 11 illustrates the present invention in its preferred embodiment. The electronic vanity display device 10 is affixed to an apparatus for transportation 50 for viewing text, graphics and digital photographs in the form of private and commercial vanity displays and in the contexts of advertising and general use. The electronic vanity display device 10 comprises a soft vanity display screen 240 in which to view text, graphics and digital photographs in the form of private and commercial vanity displays and in the contexts of advertising and general use. A display composition computer 20 attached to the back of the soft vanity display screen in which to create vanity displays out of text, graphics and digital photographs and in the contexts of advertising and general use and an audio speaker 250 for listening to audio transmissions. The electronic vanity display device is powered by a wiring harness 40.

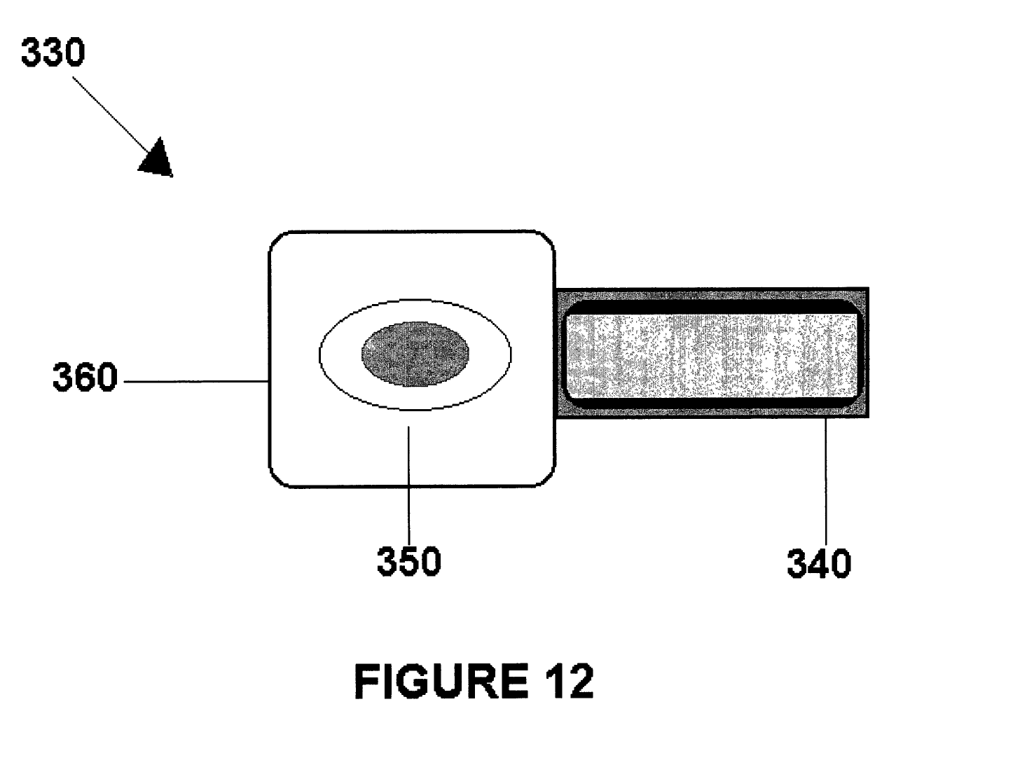

FIG. 12 illustrates the media sharing apparatus 320 of the present invention. The media sharing apparatus 320 comprises a sensor eye 330 and video camera 340 and storage facilities 350. The sensor eye 330 of the media sharing apparatus 320 is utilized to send preexisting and predetermined media and vanity displays to another apparatus for transportation 50 also using an electronic vanity display device 10 with a media sharing apparatus 320. The video camera 340 of the media sharing apparatus 320 acts a standard video recording device. It records, plays, and stores recorded media and uses such media to create vanity displays. Also recordings are combined with other media to create vanity displays.

### ALTERNATIVE EMBODIMENTS

There are various possibilities with regard to the relative disposition of the construction of the Electronic Vanity Display Device. As an alternative embodiment, it is constructed to allow the display composition computer and the vanity display screen to communicate without the use of a wiring harness. There are numerous wireless communication methods and apparatus' that permit the display composition computer to communicate to the vanity display screen. As an example, a simple radiofrequency transceiver technology can be employed as a wireless communication capability. As another example, the display composition computer and the vanity display screen can have built-in cell phone technology to communicate between the two devices. As another example, the display composition computer links to the Internet to upload a composed display into a shared data access location and the vanity display screen wirelessly links to the Internet to download a composed display from the shared data access location.

As an alternative embodiment, the vanity display screen is constructed to use portable power supply, such as at least one battery. The battery can be a disposable type, such as an alkaline battery, or the battery can be a rechargeable type, and a rechargeable battery may comprise one of the several rechargeable technologies, such as the nickel-cadmium or the lithium rechargeable chemical technologies. The battery recharging port 110 provides access to the batteries for the vanity display device 10. As an alternative embodiment, the vanity display screen is constructed to use solar energy via a solar cell collector technology for power. The vanity display screen has a simple solar energy collector system similar to those systems built into calculators, such that the energy is collected and stored for use at a later time, or is collected and used during the time of operation.

As an alternate embodiment the display composition computer is constructed in the shape of a hand glove and worn by the user to implement displays upon the vanity display screen.

As an alternate embodiment the display composition computer is constructed in the shape of a pulse gun or wand and can implement displays on the soft vanity display screen. As an example a user operates the vanity display screen from across the distance of an apparatus of transportation.

As an alternate embodiment, the display composition computer is constructed to act as a remote for a built in guidance system, stereo deck, CD player, car alarm, car opening and start up.

As an alternate embodiment the display composition computer can be made up of multiple detaching smaller pieces for multiple operators to use and then fit back together as one piece such as a CD deck face plate detaches and is reattached at a later time.

### CONCLUSION

The Electronic Vanity Display Device is a method and apparatus to permit a person to express their present thoughts and feelings in real-time to be displayed on the exterior of an object to which the vanity display screen can be attached. It also allows for the displayed composition to be created and viewed from an apparatus for transportation. Furthermore, the Electronic Vanity Display Device has the additional advantages in that it permits the user to change the displayed composition at anytime they feel that the previous displayed composition has been outgrown without the reapplication of physically material displays; it permits the user to create new display compositions without further cost of physical material; it allows the user to create display compositions in conjuncture with new technology and application methods such as electronically stored media and electronically updated media via the Internet; and it provides a way a person can actively exhibit there current changing thoughts and feelings via real-time adaptability. The Electronic Vanity Display Device is a method and apparatus to create a new and vibrant sub-culture for advertising and help a stagnating industry flourish. The Electronic Vanity Display Device will bring vital new themes for all walks of advertising and in particular to advertising done on apparatus' for transportation. In particularly any advertising being done by a vendor on an apparatus for transportation such as meal deliveries and other delivery services. These new themes will inevitably create new employment and that employment will need people to fill it. Those people will then feel more inclined to take up space in the consumer properties of our economy thus making it a stronger and healthier one.

Those skilled in the art will recognize that the embodiments disclosed herein are exemplary in nature and that various changes can be made therein without departing from the scope and the spirit of this invention. The descriptions above and the accompanying drawings should be interpreted in the illustrative and not the limited sense. While the invention has been disclosed in connection with the preferred embodiment or embodiments thereof, it should be understood that there may be other embodiments which fall within the scope of the invention as defined by the following claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

I claim:

1. An electronic vanity display device comprising:
(a) a soft vanity display screen affixed to an apparatus for transportation,
whereby said soft vanity display screen creates vanity displays for viewing by acting as a giant soft key and reacting to the operators touch.

2. The apparatus of claim 1, wherein said soft vanity display screen has a display composition computer attached directly to it, whereby said display composition computer actively creates vanity displays and communicates the vanity displays to said soft vanity display screen for viewing.

3. The apparatus of claim 2, wherein said soft vanity display screen with a display composition computer attached directly to it is replaced by a vanity display screen, whereby said display composition computer creates vanity displays and communicates the vanity displays to said vanity display screen for viewing.

4. The apparatus of claim 3, wherein said vanity display screen is replaced by at least one display screen forming shapes and words and logos and is further replaced by multiple display screens forming logos and words and shapes, whereby two or more vanity display screens come together to form and act in standard use as one larger vanity display screen.

5. The apparatus of claim 2, wherein said display composition computer attached directly to said soft vanity display screen is replaced by multiple display composition computers, whereby, multiple operators of display composition computers work together to create separate and accumulative vanity displays simultaneously in the same apparatus for transportation.

6. The apparatus of claim 1, wherein said apparatus of transportation is selected from commercial or private or government owned animal powered transportation and human powered transportation and steam powered transportation and nuclear powered transportation and solar powered transportation and engine powered transportation and wind powered transportation and gas powered transportation such as nitrogen and helium and coal powered transportation and electrically powered transportation.

7. The apparatus of claim 6, wherein said apparatus' of transportation are selected from buggies and pull carts and bicycles and motorcycles and motor vehicles and automobiles and buses and trolleys and subways and trains and submersibles and submarines and ships and boats and parachutes and gliders and winged flyers and hot air balloons and helicopter's and airplanes and jets and rockets and satellites and spacecraft and known apparatus for transportation used by human beings.

8. The apparatus of claim 3, wherein said vanity display screen with said display composition computer attached directly to it has an audio speaker, whereby said audio speaker allows for audio transmissions to follow a vanity display when it is viewed on said vanity display screen.

9. The apparatus of claim 3, wherein said vanity display screen with a display composition computer attached directly to it further comprises a media sharing apparatus, whereby said media sharing apparatus receives and shares media with other apparatus for transportation also using said media sharing apparatus and then communicates new media as vanity displays for viewing.

10. The apparatus of claim 9, wherein said media sharing apparatus is further comprised of a sensor eye and video camera and storage facilities, whereby said video camera records media and sends that media to the vanity display screen for viewing.

11. A electronic vanity display device comprising:
(a) a soft vanity display screen and vanity display screen;
(b) a display composition computer attached directly to the soft vanity display screen and vanity display screen;
(c) multiple display composition computers used by multiple operators, whereby said multiple operators use said multiple display composition computers to create an accumulative composition and vanity displays and separate composition and vanity displays;
(d) a vanity display screen and soft vanity display screen constructed in the shape and to the specifications thereof of body parts of an apparatus for transportation;
(e) a vanity display screen and soft vanity display screen constructed over and upon the entire inside and outside frames and framework and to the specifications thereof of an apparatus for transportation.

12. The apparatus of claim 3, wherein said vanity display screen with a display composition computer attached directly it, is constructed in the shape and to the specifications thereof of body parts of an apparatus for transportation, whereby said display composition computer communicates vanity displays to said vanity display screen for viewing.

13. The apparatus of claim 12, wherein said vanity display screen constructed in the shape and to the specification thereof of body parts of an apparatus for transportation with a display composition computer attached directly to it is replaced by a vanity display screen, constructed over the entire inside and outside frame and framework and to the specifications thereof of said transportation, whereby said display composition computer creates and communicates vanity displays to said vanity display screen for viewing.

14. The apparatus of claim 12, wherein said vanity display screen constructed in the shape and to the specification thereof of body parts of an apparatus for transportation with a display composition computer attached directly to it is replaced by a soft vanity display screen with a display composition computer attached directly to it, whereby, the display composition computer communicates vanity displays to the soft vanity display screen for viewing.

15. The apparatus of claim 13, wherein said vanity display screen constructed over the entire inside and outside frame and framework and to the specifications thereof of an apparatus for transportation with a display composition computer attached directly to it is replaced by a soft vanity display screen with a display composition computer attached directly to it, whereby the display composition computer communicates vanity displays to the soft vanity display screen for viewing.

16. The apparatus of claim 14, wherein said soft vanity display screen with a display composition computer attached directly to it that is constructed to the shape and the specifications thereof of a body part of apparatus for transportation is replaced by a soft vanity display screen which acts as a giant soft key and reacts to the operators touch, whereby said soft vanity display screen creates vanity displays for viewing by acting as a giant soft key and reacting to the operators touch.

17. The apparatus of claim 15, wherein said soft vanity display screen with a display composition computer attached directly to it that is constructed over the entire inside and outside frame and frame work and to the specifications thereof of an apparatus for transportation is replaced by a soft vanity display screen which acts as a giant soft key and reacts to the operators touch, whereby said soft vanity display screen creates vanity displays for viewing by acting as a giant soft key and reacting to the operators touch.

18. The apparatus of claim 8, wherein said audio speaker attached to said vanity display screen is a two way radio, whereby multiple apparatus' for transportation can share and piggy back audio messages between one another.

19. The apparatus of claim 1, wherein said soft vanity screen reacting to an operators touch is replaced by a soft vanity screen reacting to voice actuation, whereby said voice actuation creates and sends vanity displays to said soft vanity display screen for viewing.

20. An electronic vanity display device comprising:
(a) a vanity display screen and a soft vanity display screen constructed to the shape and specifications thereof of body parts of an apparatus for transportation and to the shape and specifications thereof of the entire frame and framework of an apparatus for transportation.
